(19) United States
(12) Patent Application Publication
(10) Pub. No.: US 2024/0308297 A1
(43) Pub. Date: Sep. 19, 2024

(54) FLOW-DIRECTING INSERT, FASTENING ELEMENT, FLOW-DIRECTING SYSTEM, AND HEATING DEVICE

(71) Applicant: Webasto SE, Stockdorf (DE)

(72) Inventors: Christoph Hampel, Stockdorf (DE); Vitali Dell, Stockdorf (DE)

(21) Appl. No.: 18/268,452

(22) PCT Filed: Dec. 17, 2021
(86) PCT No.: PCT/EP2021/086551

§ 371 Date: Jun. 20, 2023

(30) Foreign Application Priority Data
Dec. 21, 2020 (DE) 10 2020 134 333.7

(51) Int. Cl. B60H 1/22

(52) U.S. Cl. CPC B60H 1/2212; B60H 2001/2271; B60H 2001/2281

(57) ABSTRACT

A flow-directing insert for a heating device having an evaporator burner, wherein: the evaporator burner has a fan chamber or combustion air pre-chamber, an evaporator holder and a combustion chamber, the evaporator holder has a base wall and a circumferential wall with at least two combustion air passage openings to direct combustion air from the fan chamber or combustion air pre-chamber initially along an exterior of the evaporator holder through the combustion air passage openings into the combustion chamber, the flow-directing insert comprises at least a first region for positioning over at least one of the combustion air passage openings and a second region for fixing in the fan chamber or combustion air pre-chamber of the evaporator burner, the first region being in the shape of a tongue.

### CROSS-REFERENCE TO RELATED APPLICATIONS

The present application is a national stage application filed under 35 U.S.C. § 371 of International Application No. PCT/EP2021/086551, filed Dec. 17, 2021, which claims priority to German Patent Application No. 10 2020 134 333.7, filed Dec. 21, 2020. Each of the aforementioned patent applications is incorporated by reference in its entirety for all purposes.

The disclosure relates to a flow-directing insert, a fastening element, a flow-directing system and a heating device, in particular a mobile heating device for vehicles.

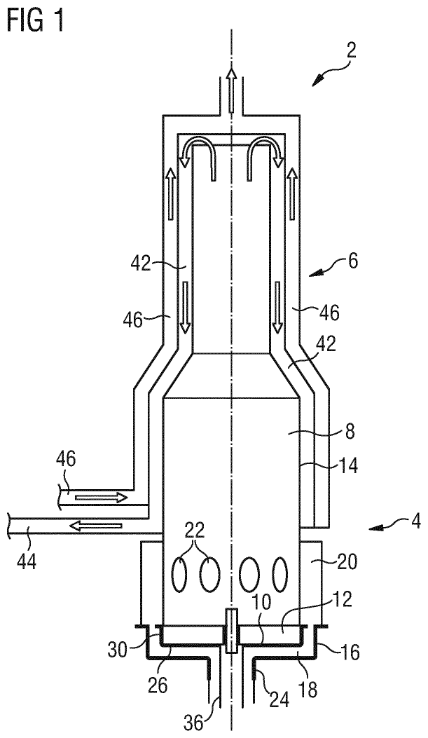

Heating devices with an evaporator burner are used in parking and/or auxiliary heaters operated with liquid fuel, which are used in particular for vehicles. FIG. 1 shows a heating device with an evaporator burner according to the prior art as described in DE 10 2012 100 173 B4. This heating device 2 is designed as a mobile, fuel-powered heating device for a parking heater of a motor-driven land vehicle. The evaporator burner 4 itself has, among other things, a combustion chamber 8, an evaporator receptacle 10 and an evaporator element 12 for evaporating liquid fuel. Combustion chamber 8, evaporator receptacle 10 and evaporator element 12 are designed to be substantially rotationally symmetrical. The combustion chamber 8 is bounded in the circumferential direction by a circumferential combustion chamber wall 14. On the end face in the region of the fuel supply, which is given by a fuel supply tube 36 and a combustion air inlet 24, the combustion chamber 8 is bounded by the evaporator receptacle 10. The evaporator receptacle 10 accommodates the evaporator element 12 on the side facing the combustion chamber 8. The evaporator burner 4 further comprises a combustion air guiding element 16 on the side of the evaporator receptacle 10 facing away from the combustion chamber 8. The combustion air guiding element 16 is cup-shaped and is fitted over the evaporator receptacle 10 in a manner similar to a cap.

A combustion air pre-chamber 20 is formed annularly around the combustion chamber 8. A gap 18 between the base wall 26 and the evaporator receptacle 10 opens into the combustion air pre-chamber 20. From the combustion air pre-chamber 20, a fluid connection is in turn established with the combustion chamber 8 via combustion air passage openings 22 formed in the combustion chamber wall 14. The gap 18 between the base wall 26 of the evaporator receptacle 10 and the combustion air guiding element 16 extends continuously over the entire area of the base wall 26 (except for the area of the combustion air inlet 24), so that the base wall 26 is cooled over substantially its entire area (except for a central area).

The fuel supply tube 36 is disposed within the stub-shaped combustion air inlet 24 so that, in use, combustion air flows around it and is thereby cooled to prevent the fuel from being prematurely vaporized and ignited directly as it enters the evaporator element 12, which can cause combustion to pulse. A first flow path 42 for the exhaust gases is formed in a heat exchanger 6. The exhaust gases flow within the heat exchanger 6 along the first flow path 42 to an exhaust outlet 44, through which the exhaust gases are directed to the outside. Furthermore, a second flow path 46 is provided within the heat exchanger 6 in which cooling fluid of the motor vehicle is guided. The first 42 and the second 46 flow paths are arranged in such a way that, in use, heat is effectively transferred from the exhaust gases to the cooling fluid.

For assembly reasons, the bell-shaped combustion air guiding element 16 must be interrupted in at least one location. This interruption can be used to arrange a fuel supply tube 36 or a glow plug of the burner.

In such an evaporator burner, while the burner is on, there is a turbulent flame. Such a flame has a noise spectrum which, for hydrocarbon-based fuels, ranges from 100 Hz to 1000 Hz. Here, the loudness or amplitude depends, among other things, on the combustion rate, local air number and turbulent mixing. In a heating system, the geometry of combustion chamber, heat exchanger and burner pre-chamber also plays a role, which can amplify or reduce sound transmission depending on the frequency. Fluctuations in the mass flow of air conveyed by the combustion air blower are reflected in fluctuations in the air ratio.

At certain frequencies, a feedback mechanism can occur in which sound generated by the flame interacts again directly or indirectly with the flame with a certain time delay and is amplified by the combustion reaction. This is a combustion instability. As a result of this process, certain frequencies are amplified to locally greatly increased sound pressure amplitudes compared to the broadband background noise, which are perceived as unpleasant operating noise in a heater.

To avoid such disturbing operating noises, according to the prior art, either the geometry of relevant parts of the burner or even the entire burner must be changed, or the burner must be operated in a different power range or at a different air ratio. Often, such problems are only discovered at a late stage of burner development, resulting in high costs to eliminate the problem. Furthermore, the aforementioned changes also affect the combustion process, emission, performance, etc., so that often only a compromise is possible here.

Furthermore, it is desirable that in order to meet different requirements, e.g. in terms of exhaust emissions and operating conditions, heaters are modular, so that different components can be combined. This involves burners or blowers but also the retrofitting of catalytic converters, as known, for example, from EP 3 348 905 A1.

It is the object of the disclosure to provide a way to optimize the noise spectrum of a heating device at a late stage of development. In particular, it is an object of the disclosure to provide a flow-directing insert, a fastening element for a flow-directing element, an improved flow-directing system and an improved heating device, in particular a mobile heating device for vehicles.

The object of the disclosure is solved with respect to the flow-directing insert by the features of claim 1, with respect to the fastening element by the features of claim 6, with respect to the flow-directing system by the features of claim 8 and with respect to the heating device by the features of claims 9 and 10. Useful embodiments result from the respective subclaims.

The flow-directing insert according to the disclosure is configured for insertion into a heating device having an evaporator burner.

The evaporator burner has a fan chamber or combustion air pre-chamber, an evaporator receptacle and a combustion chamber. The evaporator receptacle has a base wall and a circumferential wall with at least two combustion air passage openings. The fan chamber or combustion air pre-chamber is at least partially bounded outwardly by a wall and downwardly by a fan chamber floor or combustion air pre-chamber floor. The evaporator receptacle is inserted into this fan chamber or combustion air pre-chamber with the base wall first, so that the base wall partially closes off the fan chamber or combustion air pre-chamber to the top. Combustion air from the fan chamber or combustion air pre-chamber is initially directed along an outer surface of the evaporator receptacle through the combustion air passage openings of the circumferential wall into the combustion chamber.

The flow-directing insert includes at least a first portion for overlying at least one of the combustion air passage openings and a second portion for being fixed in a fan chamber or combustion air pre-chamber of the evaporator burner, the first portion being tongue-shaped. The flow-directing insert is configured for placement on an exterior surface of the evaporator receptacle.

The flow-directing insert or liner is configured to be disposed in the fan chamber or combustion air pre-chamber of the evaporator burner, as required, and to extend with its first region, at least in sections, substantially parallel to a circumferential wall of an evaporator receptacle. By substantially parallel is meant here parallel or deviating therefrom by a maximum of 10°. This includes that the flow-directing insert follows a curved contour of a circumferential wall of an evaporator receptacle. The extension of the first region follows in particular a main flow direction of the combustion air along the evaporator receptacle, which in particular has a circumferential wall that is rotationally symmetrical with respect to a longitudinal axis. The first region preferably also extends along this longitudinal axis. In particular, the flow-directing insert has a bending point between the first and second regions, so that the second region extends at least partially along a base wall of the evaporator receptacle.

The flow-directing insert reduces pressure fluctuations. In particular, the amplitude of pressure fluctuations generated in the flame of the evaporator burner and radiated toward the blower is reduced. The distance between the flow-directing insert and the circumferential wall is selected so that a supply of combustion air through this hole is not throttled, at least not appreciably. For this purpose, the distance s between the circumferential wall is to be selected such that an entrance area of the combustion air supply passage opening A corresponds minimally to the surface area Aᵣ available for the inflow of combustion air. Thus, the distance s should not be less than a quarter of the hole diameter.

The flow-directing insert according to the disclosure can superimpose one or more combustion air passage openings. The flow-directing insert according to the disclosure can be used to optimize the noise spectrum at a late stage in the development of an evaporator burner or heating device, respectively. A modular design is thus made possible, since individual components that have already been developed can thus be subsequently matched to one another. In particular, the flow-directing insert can be used in areas where a distance between the blower housing wall and the circumferential wall is increased, e.g. due to installed components.

In one embodiment, the second region is adapted to be fixed to the evaporator receptacle in the region of the base wall of the evaporator receptacle. For this purpose, the second region may comprise a fixing region, e.g. comprising one or more perforations or a clamping device. In particular, the second region may be configured for force-fitting or form-fitting connection to the evaporator receptacle or to an element arranged and fixed in the fan chamber. Alternatively or additionally, the second region may comprise support elements for supporting against a blower housing.

The flow-directing insert is expediently made from a metal sheet, in particular in one piece. In particular, it may be a bending element.

In a further embodiment, the first region has a projection or bulge which is arranged in the region of the combustion air passage openings to be superimposed or in the flow direction downstream of the combustion air passage openings to be superimposed for support against the circumferential wall. Such a protrusion or bulge is directed towards the circumferential wall. In this case, a protrusion can be formed by embossing from the outside. A protrusion for bearing against the circumferential wall serves to provide a minimum clearance between the circumferential wall and the flow-directing insert without obstructing airflow.

In a further embodiment, a plurality of first regions are interconnected via a common second region, the first regions projecting from the second region in a tongue-like manner.

The fastening element according to the disclosure for a flow-directing element is configured for insertion into a fan chamber or combustion air pre-chamber of the evaporator burner, wherein the fastening element comprises at least one flow-directing insert as described above. Such a flow-directing element has a body and a flow-through opening for distributing air from the blower uniformly to the combustion air flow-through openings. In particular, the mounting member may include a planar region which is a second region for one or more flow-directing inserts and from which first regions extend in a tongue-like manner. The one or more first regions extend in particular in radial and/or perpendicular direction from the planar region.

In an embodiment, the fastening element comprises 1-20 flow-directing inserts, in particular 2 to 10.

The fastening element can be used to fasten a flow-directing element in the heating device, in particular a fan chamber or firing pre-chamber, in a simple manner. In a first embodiment, the fastening element is suitable for itself being clamped against the wall of the fan chamber or combustion pre-chamber, in particular blower housing, in order to fasten the flow-directing element and fix it in a fixed position. For this purpose, the fastening element can have projections which engage in the recesses of the wall or are supported against a smooth wall. Alternatively or additionally, the fastening element is suitable for clamping the flow-directing element in such a way that the flow-directing element itself is clamped against fan chamber or combustion pre-chamber.

In an embodiment, the fastening element is a spring element, in particular a spring element formed from a spring steel, preferably in one piece. In a further embodiment, the spring element is formed at least partially from plastic, from spring steel and plastic or exclusively from plastic. In particular, such a spring element may have two, three, four or more projections towards the blower housing and an equal number of tongues directed inwardly towards the outflow region of the flow-directing element. In an embodiment, the spring element does not have a closed shape in the circumferential direction, but an opening which can be used to bring the fastening element into position by means of a deformation. This opening is in particular aligned with a recess of the flow-directing element. The flow-directing element has recesses, in particular on the upper side, into which the fastening element is inserted, and which are designed, in particular for the tongues and/or projections, in such a way that the flow-directing element and fastening element fit together in exactly one orientation. Furthermore, the fastening element, in particular the spring element, in particular the tongues of the spring element can be designed to come into contact with an evaporator receptacle or evaporator holder, in particular a bottom-side projection of the evaporator receptacle or evaporator holder, in the installed state. The spring element can be advantageously clamped by the pressure of the bottom-side projection on the tongues.

The flow-directing element for a heating device according to the disclosure, in particular a heating device with an evaporator burner, comprises a flow-directing element and a fastening element according to the disclosure.

The flow-directing element for a heating device, in particular a heating device with an evaporator burner, comprises a body which has a laterally arranged inflow region on an underside of the flow-directing element, a centrally arranged outflow region which comprises an opening from an underside of the flow-directing element to an upper side of the flow-directing element opposite the underside, and at least one directing element which is arranged to allow flow-directing from the inflow region to the outflow region. On a side facing away from the directing element or elements, i.e. the upper side of the flow-directing element, the flow-directing element has recesses for inserting a fastening element for fixing in a fan chamber of an evaporator burner.

The bottom side and the top side of the flow-directing element are two opposite sides of the flow-directing element. Here, the bottom side is suitably configured with a supporting surface, and the top side is configured to be aligned with an evaporator receptacle in a state installed in the heating device. An outer shape, in particular seen in projection on the upper side of the flow-directing element is adapted to the shape of the receiving heating device, in particular a combustion air pre-chamber. The flow guiding element according to the disclosure is particularly suitable for a heating device with a blower arranged offset from a central axis, i.e. eccentrically. The flow-directing element thus guides an air flow from the blower to the central outflow region in a simple and cost-effective manner.

The air directing elements can expediently be formed by projections or walls arranged on the underside of the flow-directing element, so that channels open towards the underside are formed on the flow-directing element. Alternatively, the flow-directing elements can also be formed by closed channels.

Expediently, the flow-directing element is a molded plastic part, in particular an injection-molded plastic part. Such a molded plastic part is inexpensive to manufacture and simplifies assembly. Suitable plastics include, for example, polyphenylene sulfite (PPS) or PPS reinforced with glass fibers, in particular PPS GF 40. In a further embodiment, the flow-directing element is formed at least partially or exclusively from a metallic material or is formed from metallic material and one of the aforementioned plastics.

In an embodiment, the flow directing element has a recess for inserting a glow plug, which is arranged in particular on a side opposite the inflow region, in particular the upper side of the flow-directing element.

In a further embodiment, the inflow region is designed to accommodate a blower, the inflow region being designed in particular as a bulge. The bulge is curved towards the upper side of the flow-directing element. The underside of the bulge is open. In a further embodiment, the inflow region, in particular the inflow region configured as a bulge, can have a secondary outflow opening. In particular, the secondary outflow opening is designed and arranged to form a through-hole through a wall of the bulge and to guide a portion of the airflow to cool a glow plug, while the main portion of the airflow continues to be guided from the inflow region to the outflow region.

The one or more directing elements are suitably configured to spread the airflow from the inflow region to the outflow region in a fan-like manner, and/or to split the airflow from the inflow region and direct a first portion to the outflow region and direct a further portion circumferentially around the outflow region and then radially inwardly to the outflow region at one or more openings. The one or more directing elements can be used to create a controlled flow profile. In order to guide a part of the air flow in the circumferential direction, a circumferential wall at the outflow region, which has one or more apertures, can be provided.

The heating device according to the disclosure with an evaporator burner and with a fan chamber has a flow-directing insert according to the disclosure. Alternatively or additionally, the heating device according to the disclosure and has an off-center blower and comprises a flow directing element according to the disclosure.

The flow-directing element can be received in the fan chamber in a self-centering manner.

The flow-directing insert is suitably detachably connected to the heating device.

The disclosure is also explained in more detail below with respect to further features and advantages by means of the description of embodiment examples and with reference to the accompanying drawings. It shows in each case in a principle sketch:

FIG. 1 Heating device according to prior art;

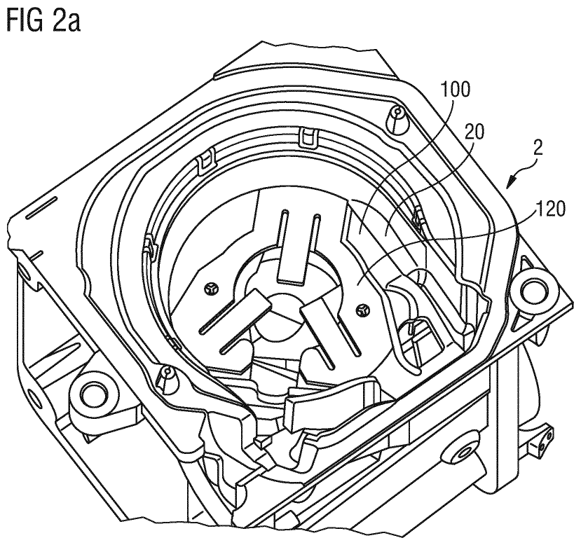

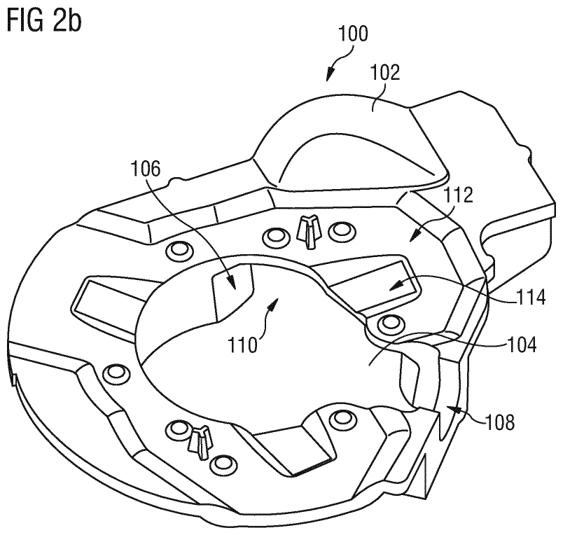

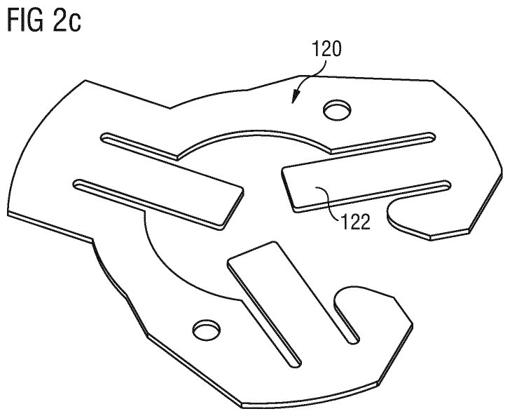

FIG. 2a-c View of an open heating device, a flow-directing element and fastening element without flow-directing insert;

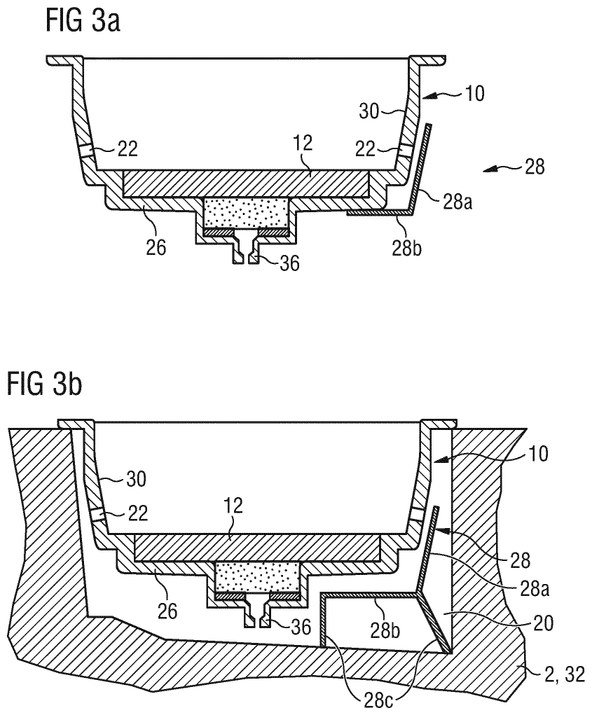

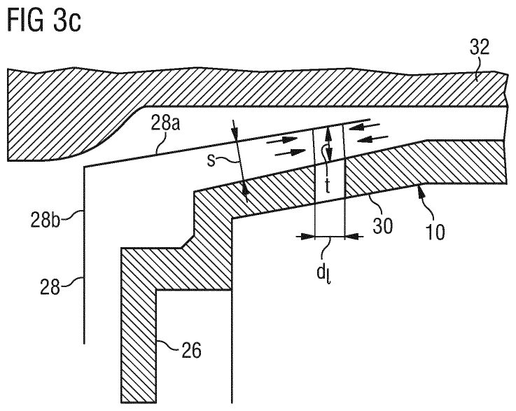

FIG. 3a-c embodiment of a flow-directing insert;

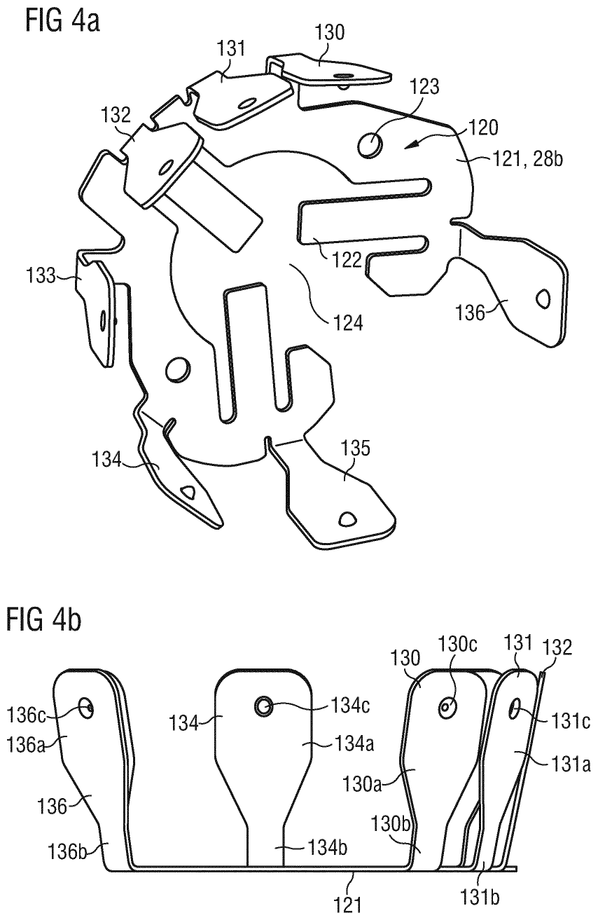

FIG. 4a-c view of an embodiment of a fastening element with flow-directing insert; and

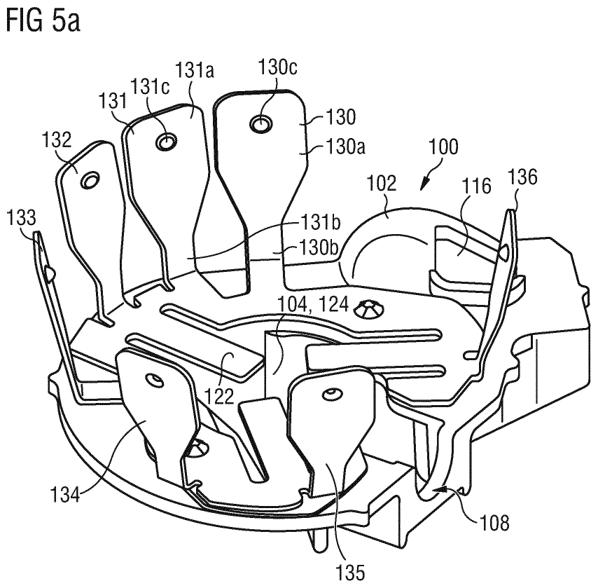

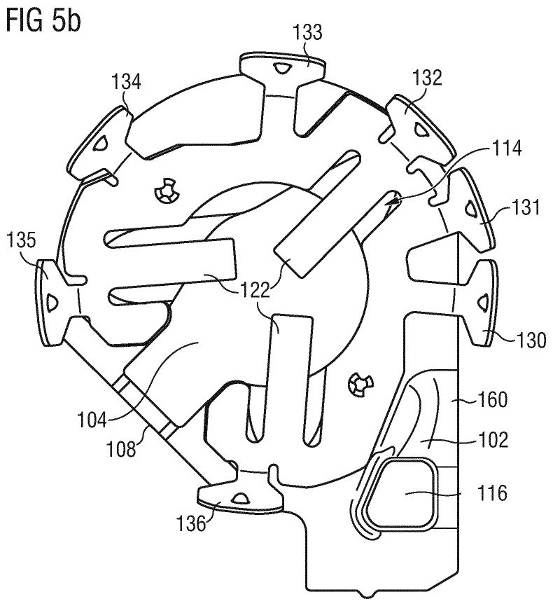

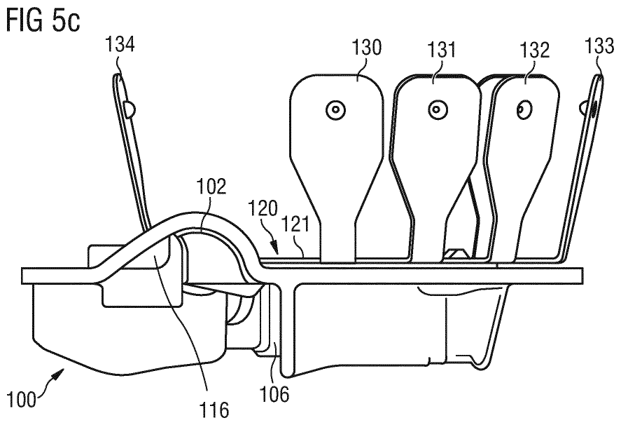

FIG. 5a-c embodiment of a system.

FIG. 2a shows a view of an open heating device with a flow-directing element 100 inserted in a combustion air pre-chamber 20 and a fastening element 120 without a flow-directing insert. A bottom surface of the flow-directing element 100 rests on a top surface of a bottom of the combustion air pre-chamber 20. The fastening element 120 is arranged on the upper surface of the flow-directing element 100. The fastening element 120 is thus arranged towards an evaporator receptacle or evaporator support, which is not shown. In particular, the tongues 122 of the fastening element 120 are designed to come into contact with a dome or bottom protrusion of the evaporator receptacle or evaporator holder, when installed. By the pressure of the bottom protrusion of the evaporator receptacle or evaporator holder on the tongues 122, the fastening element 120 designed as a spring element can be advantageously clamped. With the aid of the fastening element 120, the flow-directing element 100 is thus held in the desired position.

FIG. 2b shows a flow-directing element. This flow-directing element 100 has an outer border which is adapted to a receiving area in a combustion air pre-chamber. The flow-directing element 100 has an inflow region 102 in an outer region, which is adapted to the position of a blower. This is an off-center blower arranged in an off-center position.

Further, the flow-directing element 100 has a central outflow region 104 which allows air to pass from a bottom side of the flow-directing element 100 to a top side of the flow-directing element 100. Directing elements 106 are arranged on the underside of the flow-directing element 100. Openings 110 are arranged between or adjacent the one or more directing elements 106 to allow air to exit to the outflow region 104. The directing elements 106 in the area of the underside may be configured in different ways. For example, the flow-directing element 100 may be a molded plastic part.

The flow-directing element 100 has a recess 108 for receiving a glow plug. Further, a first recess 112 and a second recess 114 are shown in the top surface shown in FIG. 2b. The first recess has a peripheral shape of the fastening element 120 shown in FIG. 2c. The fastening element 120 can be inserted into the first recess 112 and the second recess 114. The fastening element 120 can be used to easily fasten the flow-directing element in the heating device, in particular a fan chamber or a combustion pre-chamber. This fastening element 120 has three projections extending radially outward. The second recesses 114 are configured for the three inwardly directed tongues 122 of the fastening element 120. The fastening element 120 does not have a closed shape in the circumferential direction, but rather an opening which can be used to bring the fastening element 120 into position by means of a deformation. This opening is designed to be aligned with the recess 108 of the flow-directing element 100. Here, the fastening element is suitable for clamping the flow-directing element 100 as well as for supporting the flow-directing element 100 against a wall of the fan chamber 20 by means of two of the protrusions. The fastening element 120 is preferably a spring element, which may be made of a spring steel, for example.

FIG. 3a shows a first embodiment of a flow-directing insert 28. The flow-directing insert 28 is externally attached to an underside of the evaporator holder 10 of the evaporator burner 4. The evaporator holder 10 includes a base wall 26 having a supply tube 36. The evaporator holder 10 further comprises a circumferential wall 30 which is, at least in sections, conical or cylindrical in shape, i.e. rotationally symmetrical about a longitudinal axis. Two combustion air passage openings 22 are arranged in the circumferential wall 30. The flow-directing insert 28 has a first region 28a and a second region 28b. The first region 28a extends along the circumferential wall 30 and overlies a combustion air passage opening 22. First region 28a and circumferential wall 30 are substantially parallel in sections. An evaporator element 12 is further received within the evaporator receptacle 10. Second region 28b extends substantially parallel to base wall 26. In the example shown, the second region is attached to the base wall 26.

FIG. 3b shows another embodiment of a flow-directing insert 28. In this embodiment, the blower housing 32 is further shown with the fan chamber or combustion air pre-chamber 20. The embodiment shown differs in that the second region 28b of the flow-directing insert 28 is not attached to the evaporator receptacle 10, but includes support elements 28c. With the support elements 28c, the flow-directing insert 28 is supported against the blower housing 32 or stands in the fan chamber.

FIG. 3c shows a flow-directing insert 28 between blower housing 32 and evaporator receptacle 10. The flow-directing insert 28 has a first region 28a and a second region 28b. The first region 28a has a distance s from the circumferential wall 30 of the evaporator holder 10. This distance does not change substantially between the position indicated by s and the position indicated by t. The combustion air passage openings 22 of the circumferential wall 30 has a diameter dₗ. Thus, an entrance surface of the combustion air passage openings 22 has an area

$${A}_{l} = \frac{{d}_{l}^{2}}{{A}_{\text{?}}} π$$

$$\text{?} \text{indicates text missing or illegible when filed}$$

For the inflow of the combustion air, the circumferential surface Aᵣ with height s can be assumed:

Aᵣ=dₗns

The distance s between circumferential wall should be selected so that an entrance area of the combustion air supply passage opening Aₗ is minimally equal to the shell area Aᵣ available for the inflow of combustion air. Thus, the distance s should not be less than a quarter of the hole diameter.

FIGS. 4a to c show views of a fastening element 120 of one embodiment. Like the fastening element of FIG. 2c, the fastening element 120 has three inwardly pointing tongues 122 and a central opening 124. Furthermore, perforations 123 are arranged in the sheet area to serve as positioning aids. These are optional. The planar region 121 of the fastening element 120 is further second region 28b of the flow-directing insert(s). In the example shown, the fastening element 120 has seven flow-directing inserts 130, 131, 132, 133, 134, 135, 136. Each of these flow-directing inserts 130, 131, 132, 133, 134, 135, 136 includes a tongue-shaped portion 130a, 131a, 132a, 133a, 134a, 135a, 136af, the respective first region of the flow-directing insert, which extend nearly perpendicular to the planar region 121, the common second region 28b. The tongue-shaped sections 130a, 131a, 132a, 133a, 134a, 135a, 136a optionally have narrower bending regions 130b, 131b, 132b, 133b, 134b, 135b, 136b at the transition between the respective first and second regions. Furthermore, the tongue-shaped sections 130a, 131a, 132a, 133a, 134a, 135a, 136a each have a bulge 130c, 131c, 132c, 133c, 134c, 135c, 136c which are curved towards the center, i.e. towards the evaporator burner to be used. In the case shown, the bulges 130c, 131c, 132c, 133c, 134c, 135c, 136c ensure a minimum distance to the circumferential wall 30 (not shown) of the centrally inserted evaporator receptacle. A design with more or fewer flow-directing inserts is possible in an analogous manner.

FIGS. 5a-c show views of a flow-directing system comprising a mounting element 120 as shown in FIG. 4 and a flow-directing element 100 as shown in FIG. 2b. Here, in the embodiment shown in FIGS. 5a-c, the flow-directing element 100 has an optional secondary outflow opening 116 in the region of the inflow region 102 formed as a bulge. While the outflow region 104 is formed substantially as a central through-hole in the flow-directing element 100 and is arranged in alignment with the central opening 124 of the mounting element 120, the secondary outflow opening 116 is arranged off-center. Flow through the outflow region 104 is directed toward and along the base wall 26 of the evaporator holder 10. Air flow through the secondary outflow opening 116 can be used to cool a glow plug arranged in the recess 108.

### I. REFERENCE SIGNS

2 heating device
4 evaporator burner
8 combustion chamber
10 evaporator receptacle
12 evaporator element
16 combustion air guiding element
14 combustion chamber wall
18 gap
20 combustion air pre-chamber
22 combustion air passage openings
24 combustion air inlet
26 base wall
28 flow-directing insert
28a first region
28b second region
28c support element
30 circumferential wall
32 blower housing
36 supply tube
42 first flow path
44 exhaust outlet
46 second flow path
100 flow-directing element
102 inflow region
104 outflow region
106 directing element
108 recess
110 opening
112 first recess
114 second recess
116 secondary outflow opening
120 fastening element
121 planar region of fastening element
122 tongue
123 perforations
124 central opening
130 . . . 136 flow-directing insert
130a . . . 136a first region
130b . . . 136b bending region
130c . . . 136c bulge region
t distance
S distance
A Area
d diameter

1. A flow-directing insert for a heating device with an evaporator burner,
wherein the evaporator burner comprises a fan chamber or combustion air pre-chamber, an evaporator receptacle and a combustion chamber,
wherein the evaporator receptacle has a base wall and a circumferential wall having at least two combustion air passage openings for directing combustion air from the fan chamber or combustion air pre-chamber initially along an exterior of the evaporator receptacle through the combustion air passage openings of the circumferential wall into the combustion chamber,
wherein the flow-directing insert comprises at least a first region for superimposing at least one of the combustion air passage openings and a second region for fixing in the fan chamber or combustion air pre-chamber of the evaporator burner, wherein the first region is tongue-shaped.

2. The flow-directing insert according to claim 1,
wherein the second region is adapted to be fixed to the evaporator receptacle in the region of the base wall of the evaporator receptacle, or wherein the second region comprises supporting elements for supporting against a blower housing.

3. The flow-directing insert according to claim 1,
wherein the flow-directing insert is made of a metal sheet.

4. The flow-directing insert according to claim 1,
wherein the first region has a protrusion or a bulge which is arranged in the region of the combustion air passage openings to be superimposed or in the direction of flow downstream of the combustion air passage openings to be superimposed for support against the circumferential wall.

5. The flow-directing insert according to claim 1,
wherein a plurality of first regions are interconnected via a common second region, wherein the first regions protrude from the second region in a tongue-like manner.

6. A fastening element for a flow-directing element configured for insertion into a fan chamber or combustion air pre-chamber of the evaporator burner,
wherein the fastening element comprises at least one flow-directing insert according to claim 1.

7. The fastening element according to claim 6, which is designed as a spring element.

8. A flow-directing system for a heating device, comprising a fastening element according to claim 6 and a flow-directing element,
wherein the flow-directing element comprises a body having a laterally arranged inflow region on a bottom side of the flow-directing element, a centrally arranged outflow region comprising an opening from a bottom side of the flow-directing element to a top side of the flow-directing element opposite to the bottom side, and at least one guide element which is arranged in such a way that it enables flow-directing from the inflow region to the outflow region, wherein the flow-directing element has, on a side facing away from the directing element or elements, recesses for insertion of the fastening element for fastening in a fan chamber or combustion air pre-chamber of an evaporator burner.

9. A heating device with an evaporator burner and with a fan chamber or combustion air pre-chamber comprising a flow-directing insert according to claim 1,
wherein the evaporator burner comprises a fan chamber or combustion air pre-chamber, an evaporator receptacle and a combustion chamber, wherein the evaporator receptacle has a base wall and a circumferential wall having at least two combustion air passage openings to direct combustion air from the fan chamber or combustion air pre-chamber initially along an exterior of the evaporator receptacle through the combustion air passage openings of the circumferential wall into the combustion chamber,
wherein the first region of the flow-directing insert extends at least in sections parallel or with a deviation of less than 10° therefrom along the circumferential wall of the evaporator holder.

10. The heating device with an evaporator burner with a fan chamber or combustion air pre-chamber and an off-center blower, comprising a flow guiding system according to claim 7,
wherein the evaporator receptacle has a base wall and a circumferential wall having at least two combustion air passage openings to direct combustion air from the fan chamber or combustion air pre-chamber initially along an exterior of the evaporator receptacle through the combustion air passage openings of the circumferential wall into the combustion chamber,
wherein the first region of the flow-directing insert extends at least in sections parallel or with a deviation of less than 10° therefrom along the circumferential wall of the evaporator receptacle.

11. The flow-directing insert according to claim 1,
wherein the flow-directing insert is made of a metal sheet in one piece.
